(19) United States
(12) Patent Application Publication
(10) Pub. No.: US 2025/0291151 A1
(43) Pub. Date: Sep. 18, 2025

(54) OPTICAL ELEMENT DRIVING MECHANISM

(71) Applicant: TDK TAIWAN CORP., Taoyuan City (TW)

(72) Inventors: Ya-Hsiu WU, Taoyuan City (TW); Yi-Ho CHEN, Taoyuan City (TW); Ying-Jen WANG, Taoyuan City (TW); Sin-Jhong SONG, Taoyuan City (TW)

(21) Appl. No.: 19/074,868

(22) Filed: Mar. 10, 2025

Related U.S. Application Data
(60) Provisional application No. 63/565,279, filed on Mar. 14, 2024.

(51) Int. Cl. G02B 7/09; G03B 5/00

(52) U.S. Cl. CPC G02B 7/09; G03B 5/00; G03B 2205/0069

(57) ABSTRACT

An optical element driving mechanism is provided, which includes a movable portion, a fixed portion, and a driving assembly. The movable portion is used for connecting to an optical module and is movable relative to the fixed portion. The driving assembly is used for driving the movable portion to move.

### CROSS REFERENCE TO RELATED APPLICATIONS

This application claims the benefit of U.S. Provisional Application No. 63/565,279, filed on Mar. 14, 2024, the entirety of which is incorporated by reference herein.

### BACKGROUND OF THE INVENTION

### Field of the Invention

The present disclosure relates to an optical element driving mechanism.

### Description of the Related Art

As technology has developed, it has become more common to include image capturing or recording functions into many types of modern electronic devices, such as smart phones and digital cameras. These electronic devices are used more and more often, and new models have been developed that are convenient, thin, and lightweight, and offer more choices for consumers.

Electronic devices that have image capturing or recording functions normally include a driving mechanism to drive an optical element (e.g. a lens) to move along its optical axis, thereby achieving auto focus (AF) or optical image stabilization (OIS). Light may pass through the optical element and may form an image on an optical sensor. However, the current trend in modern mobile devices is to have a smaller size and a higher durability. As a result, how to effectively reduce the size of the driving mechanism and how to increase its durability has become an important issue.

### BRIEF SUMMARY OF THE INVENTION

An optical element driving mechanism is provided in some embodiments of the present disclosure, which includes a movable portion, a fixed portion, and a driving assembly. The movable portion is used for connecting to an optical module and is movable relative to the fixed portion. The driving assembly is used for driving the movable portion to move.

In some embodiments, the optical element driving mechanism further includes a circuit assembly, the circuit assembly includes a first circuit. The movable portion includes: a first surface, a first recess formed in the first surface and having a recessed structure, a second surface located in the first recess and facing the first circuit, and a first positioning structure used for positioning the first circuit. The first surface and the second surface are parallel to each other. The first positioning structure is protruding from the second surface. And a height of the first positioning structure is less than a depth of the first recess.

In some embodiments, the movable portion further includes a first connecting element, and a first connection reinforcing structure having a recessed structure formed in the second surface. The first circuit is electrically connected to the movable portion through the first connecting element. The circuit assembly further includes a first guiding wire located in the first recess, a second guiding wire located in the first recess, a third guiding wire located in the first recess, a first electrical connecting element disposed on the first circuit, a second electrical connecting element disposed on the first circuit, and a third electrical connecting element disposed on the first circuit. The first connecting element directly contacts the first connection reinforcing structure. The first electrical connecting element is located in the first recess. The first guiding wire electrically connects the first circuit through the first electrical connecting element. The second guiding wire electrically connects the first circuit through the second electrical connecting element. The third guiding wire electrically connects the first circuit through the third electrical connecting element.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of an optical element driving mechanism.

FIG. 1B is an exploded view of the optical element driving mechanism.

FIG. 1C is a top view of some elements of the optical element driving mechanism.

FIG. 2A is a cross-sectional view drawn along line A-A of FIG. 1C.

FIG. 2B is an enlarged view of an area in FIG. 2A.

FIG. 2C is a sectional view drawn along line B-B of FIG. 1C.

FIG. 2D is an enlarged view of an area in FIG. 2C.

FIG. 2E is a cross-sectional view drawn along line C-C of FIG. 1C.

FIG. 3A is a schematic view of the movable portion.

FIG. 3B is a top view of the movable portion.

FIG. 3C is a bottom view of the movable portion.

FIG. 3D is a side view of the movable portion.

FIG. 4 is a top view of some elements of the optical element driving mechanism.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

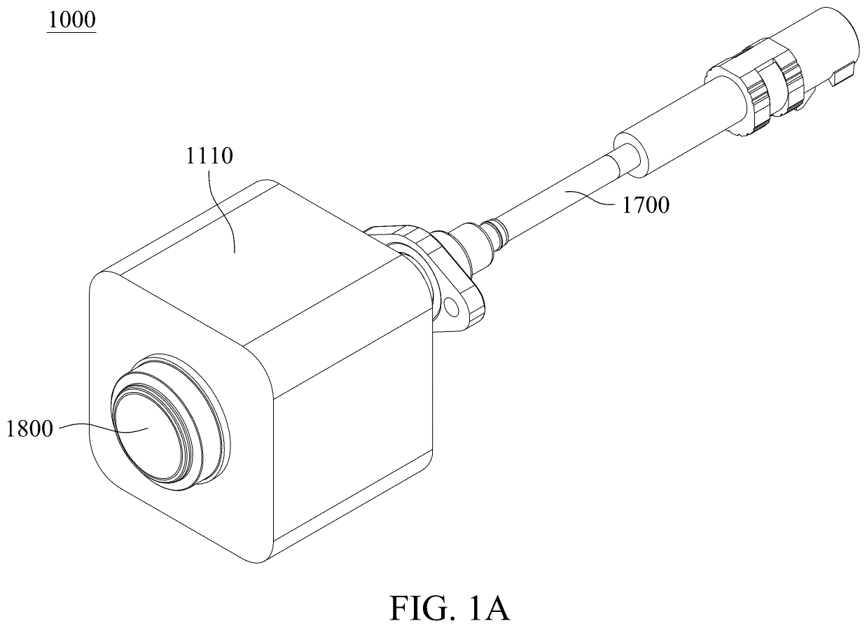

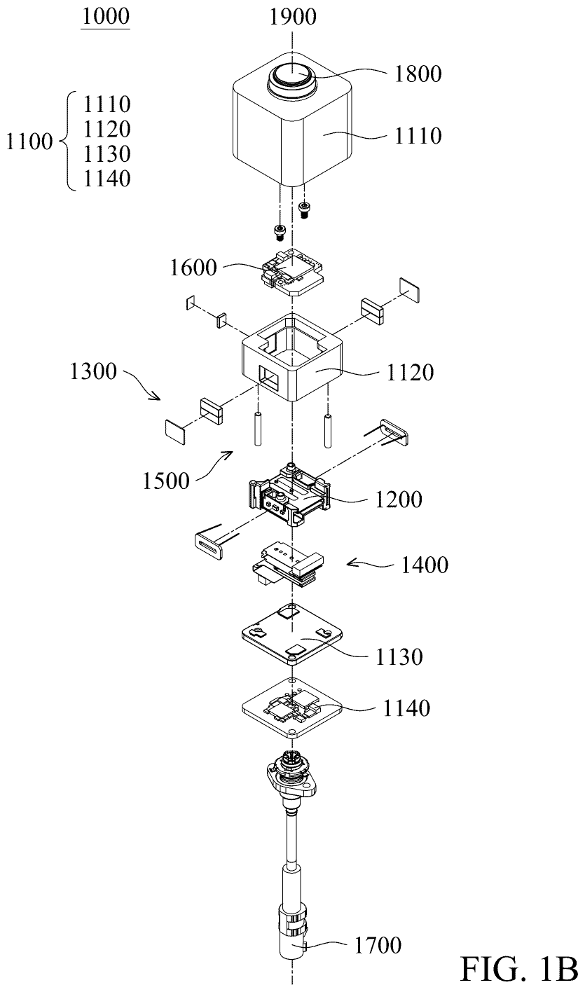

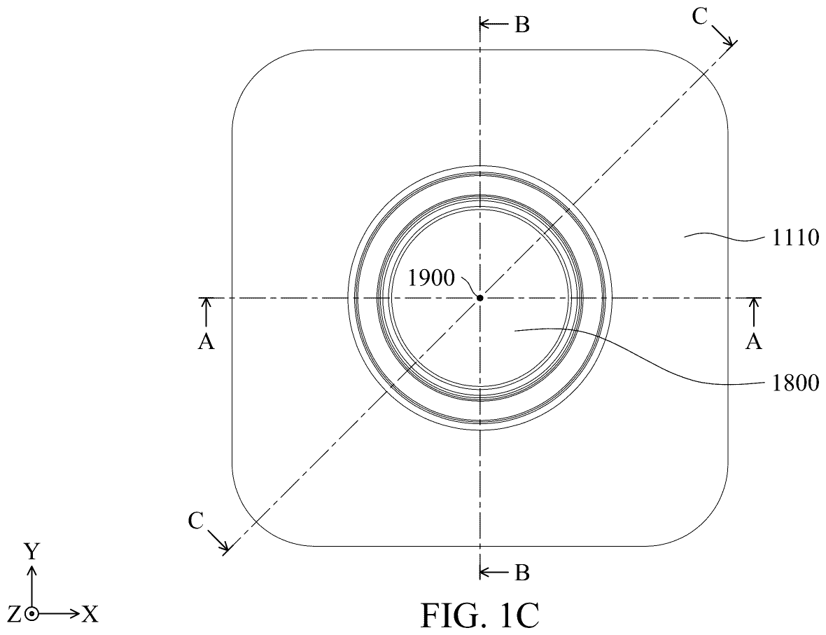

The present disclosure provides an optical element driving mechanism for driving an optical module to move. For example, FIG. 1A is a schematic view of an optical element driving mechanism 1000, and FIG. 1B is an exploded view of the optical element driving mechanism 1000.

As shown in FIG. 1A and FIG. 1B, the optical element driving mechanism 1000 may mainly include a fixed portion 1100 disposed along a main axis 1900 (including a case 1110, a frame 1120, a first bottom 1130, and a second bottom 1140), a movable portion 1200, a driving assembly 1300, a circuit assembly 1400, a support assembly 1500, and a conductive element 1700, for driving an optical module 1600 to move.

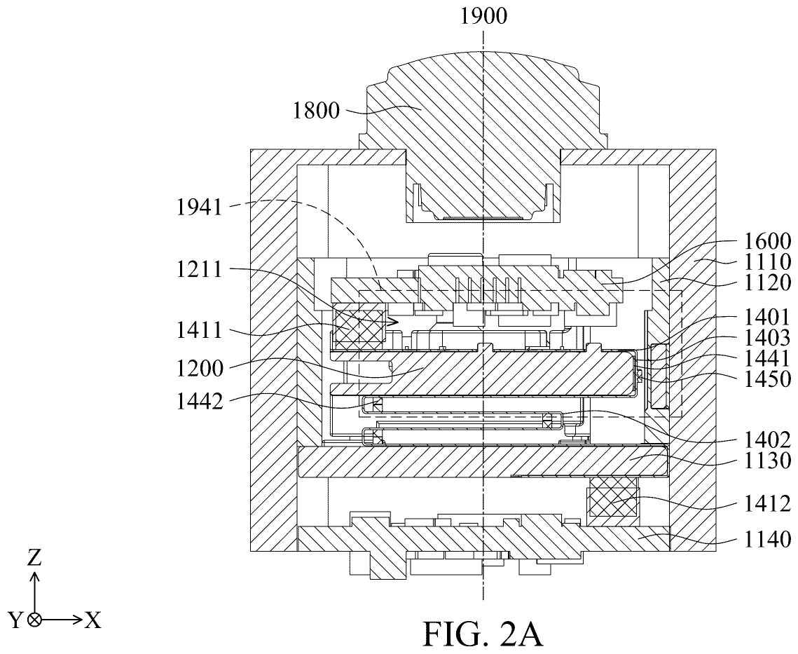

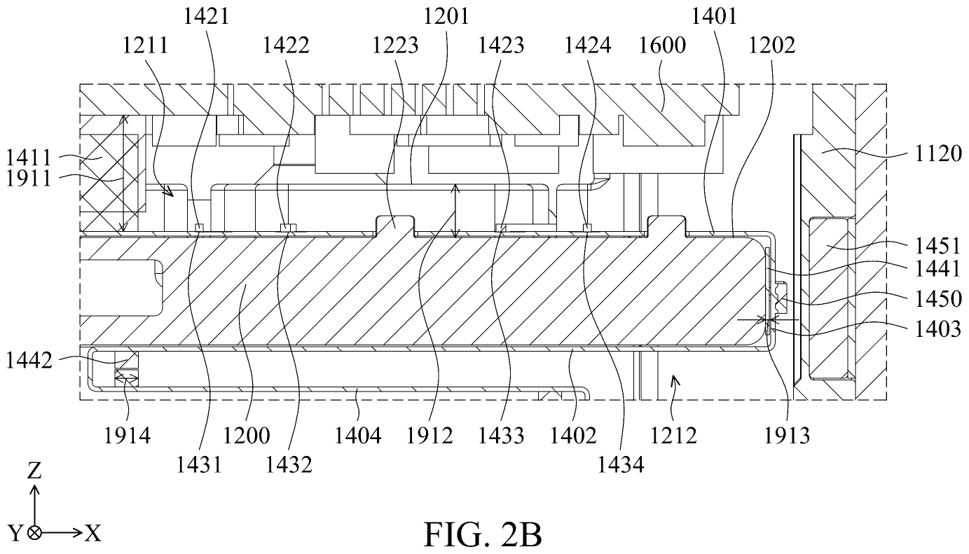

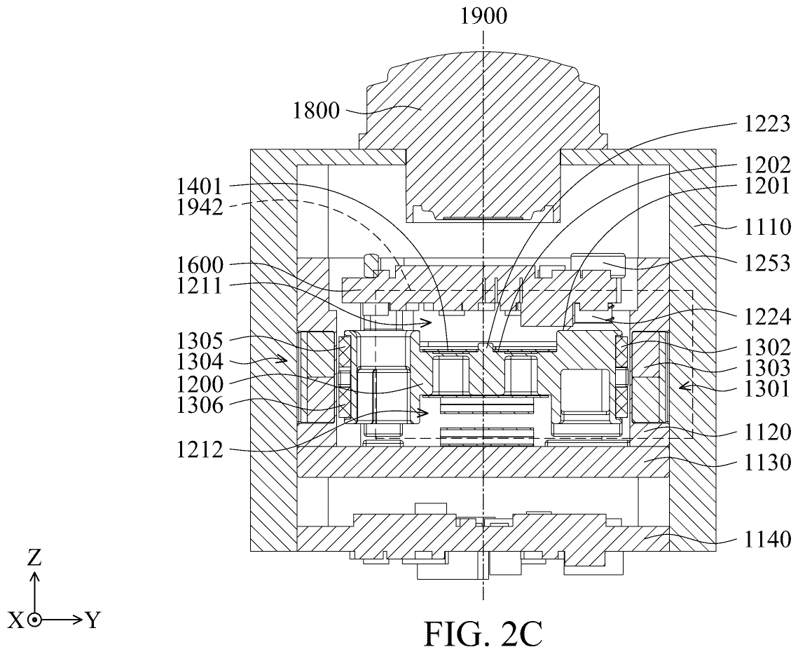

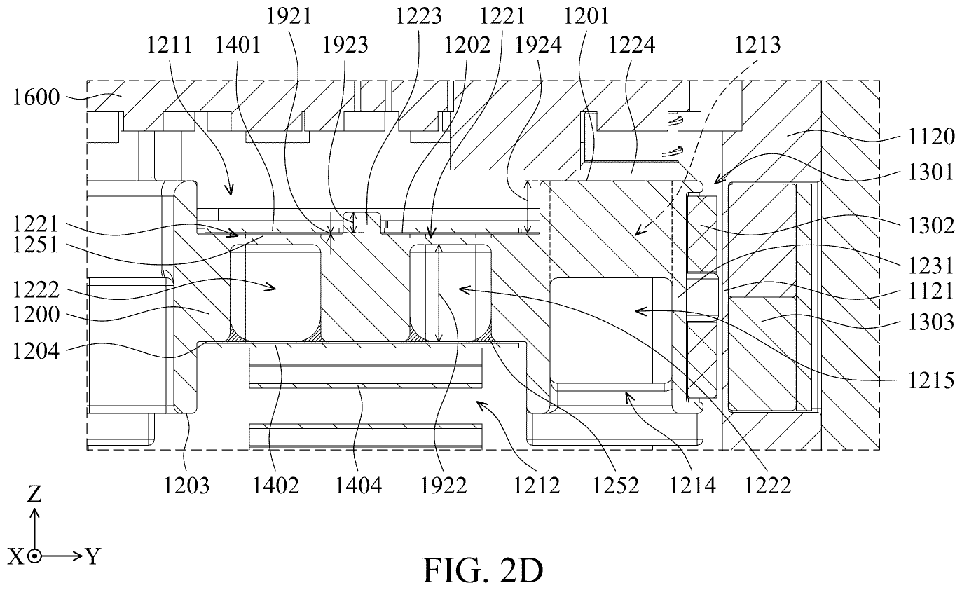

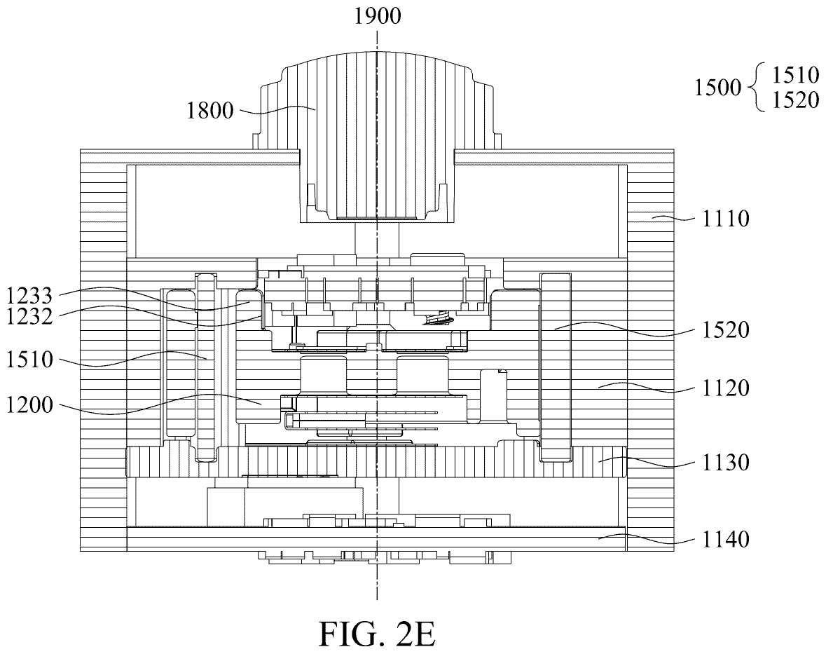

FIG. 1C is a top view of some elements of the optical element driving mechanism 1000, wherein the conductive element 1700 is omitted to better illustrate the positional relationships between the other elements. FIG. 2A is a cross-sectional view drawn along a line A-A of FIG. 1C. FIG. 2B is an enlarged view of an area 1941 in FIG. 2A. FIG. 2C is a cross-sectional view drawn along a line B-B of FIG. 1C. FIG. 2D is an enlarged view of an area 1942 in FIG. 2C. FIG. 2E is a cross-sectional view drawn along a line C-C shown in FIG. 1C.

As shown in FIG. 2A to FIG. 2E, in some embodiments, the case 1110, frame 1120, first bottom 1130, and second bottom 1140 of the fixed portion 1100 may be fixed relative to each other to allow other elements of the optical element driving mechanism 1000 being disposed on the fixed portion 1100 (for example, on the case 1110, the frame 1120, the first bottom 1130, or the second bottom 1140) to fix the positions of the elements and protect the elements.

In some embodiments, an optical element 1800 may be disposed on the fixed portion 1100, such as may be disposed on the case 1110, and the optical element 1800 may be aligned with the optical module 1600 along the main axis 1900. In some embodiments, the optical module 1600 and the optical element 1800 may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, as shown in FIG. 2A and FIG. 2C, the movable portion 1200 may be disposed within the frame 1120 and may be disposed between the case 1110 and the first bottom 1130, such as between the case 1110 and the first bottom 1130 in the direction that the main axis 1900 extends. Additionally, the second bottom 1140 and the movable portion 1200 may be located on opposite sides of the first bottom 1130. In some embodiments, the optical module 1600 may be disposed on the movable portion 1200, such as connected to the movable portion 1200 through a first connector 1411 of the circuit assembly 1400. In some embodiments, the movable portion 1200 may move relative to the fixed portion 1100 so that the optical module 1600 disposed on the movable portion 1200 may move relative to the optical element 1800 disposed on the fixed portion 1100, thereby achieving an auto focus (AF).

In some embodiments, the driving assembly 1300 may be disposed between the fixed portion 1100 and the movable portion 1200 to drive the movable portion 1200 to move relative to the fixed portion 1100. For example, as shown in FIG. 2D, the driving assembly 1300 may include a first driving element 1301 (which may include a first coil 1302 and a first magnetic element 1303) and a second driving element 1304 (which may include a third coil 1305 and a third magnetic element 1306) to drive the movable portion 1200 to move relative to the fixed portion 1100 along the main axis 1900.

For example, the first coil 1302 and the third coil 1305 may be disposed on the movable portion 1200, and the first magnetic element 1303 and the third magnetic element 1306 may be disposed on the frame 1120. When current is passed through the first coil 1302 and the third coil 1305, an electromagnetic driving force is generated between the first coil 1302 and the first magnetic element 1303, and between the third coil 1305 and the third magnetic element 1306, respectively, to drive the movable portion 1200 to move relative to the fixed portion 1100, thereby achieving the auto focus. In some embodiments, the first driving element 1301 and the second driving element 1304 may be disposed on different sides of the movable portion 1200, such as may be disposed on opposite sides of the movable portion, but it is not limited thereto. In some embodiments, the frame 1120 may include a first protection assembly 1121 located between the first coil 1302 and the first magnetic element 1303. The first protection assembly 1121 may be made of plastic or resin, have a plate-like structure, and be fixedly connected to the fixed portion 1100 to separate and protect the first coil 1302 and the first magnetic element 1303.

Although the present embodiment uses the first coil 1302, the first magnetic element 1303, the third coil 1305, and the third magnetic element 1306 as examples of the driving assembly 1300, the present disclosure is not limited thereto. In some embodiments, the driving assembly 1300 may also include driving elements such as piezoelectric elements or shape memory alloys. These driving elements may be selected according to specific application requirements to achieve the desired optical element driving function. Therefore, within the scope of the present disclosure, a suitable driving assembly may be chosen based on actual needs and technical conditions.

In some embodiments, the circuit assembly 1400 may also include a first circuit 1401, a second circuit 1402, and a third circuit 1403. The circuit assembly 1400 may be disposed on the fixed portion 1100 and the movable portion 1200 to electrically connect the elements of the optical element driving mechanism 1000. In some embodiments, the first circuit 1401, the second circuit 1402, and the third circuit 1403 may, for example, include printed circuit boards (PCB) or flexible printed circuit boards (FPC) to allow the movable portion 1200 to be movably connected to the fixed portion 1100 through the circuit assembly 1400.

In some embodiments, as shown in FIG. 2A and FIG. 2B, the circuit assembly 1400 may also include a first connector 1411 at least partially located at a first recess 1211, and may be between the circuit assembly 1400 and the optical module 1600 to electrically connect the circuit assembly 1400 and the optical module 1600. In some embodiments, in the direction that the main axis 1900 extends, a height 1911 of the first connector 1411 is different from a depth 1912 of the first recess 1211. For instance, the height 1911 may be greater than the depth 1912. In some embodiments, the first connector 1411 may include one portion fixed on the circuit assembly 1400, and may include another portion affixed on the optical module 1600, and these two portions may be connected to each other for forming the first connector 1411.

In some embodiments, as shown in FIG. 2A, the circuit assembly 1400 may also include a second connector 1412 corresponding to the first connector 1411. For example, the first connector 1411 and the second connector 1412 may be located on opposite sides of the movable portion 1200 or the first bottom 1130. The second connector 1412 may be disposed between the first bottom 1130 and the second bottom 1140 to electrically connect the second circuit 1402 with a circuit on the second bottom 1140, such as may be electrically connected to the conductive element 1700. In some embodiments, the second connector 1412 may include one portion fixed on the circuit assembly 1400 and another portion fixed on the second bottom 1140, and these two portions may be connected to each other to form the second connector 1412.

In some embodiments, as shown in FIG. 2E, the support assembly 1500 may include a first support element 1510 and a second support element 1520, which may be disposed between the fixed portion 1100 and the movable portion 1200, such as may be directly contacted to the frame 1120, the first bottom 1130, and the movable portion 1200. In some embodiments, the first support element 1510 and the second support element 1520 may be strip-shaped and extend along the main axis 1900 to define the movement direction of the movable portion 1200 relative to the fixed portion 1100. In some embodiments, the first support element 1510 and the second support element 1520 may be fixed on the fixed portion 1100, and the movable portion 1200 is movable relative to the first support element 1510 and the second support element 1520. For example, the movable portion 1200 may be disposed in frictional contact with the first support element 1510 and the second support element 1520. In some embodiments, the first support element 1510 and the second support element 1520 may be fixed on the movable portion 1200 and may move relative to the fixed portion 1100, depending on design requirements.

In some embodiments, as shown in FIG. 2C and FIG. 2D, the optical module 1600 may be fixed to the movable portion 1200 through a third connecting element 1253 and a first fixing structure 1224 on the movable portion 1200. For example, the first fixing structure 1224 may include a threaded hole, and the third connecting element 1253 may include a fixing element such as a screw or a nut, and may directly contact the first fixing structure 1224 to secure the first fixing structure 1224. In some embodiments, the movable portion 1200 may have a first surface 1201 that is perpendicular to the main axis 1900, and the first fixing structure 1224 may be disposed on the first surface 1201, such as protruding from the first surface 1201 in the +Z direction.

In some embodiments, the conductive element 1700 may extend along the main axis 1900, be disposed on the second bottom 1140, and be electrically connected to the circuit assembly 1400 through the second connector 1412 to allow signals from the optical element driving mechanism 1000 to be connected to other external devices through the conductive element 1700.

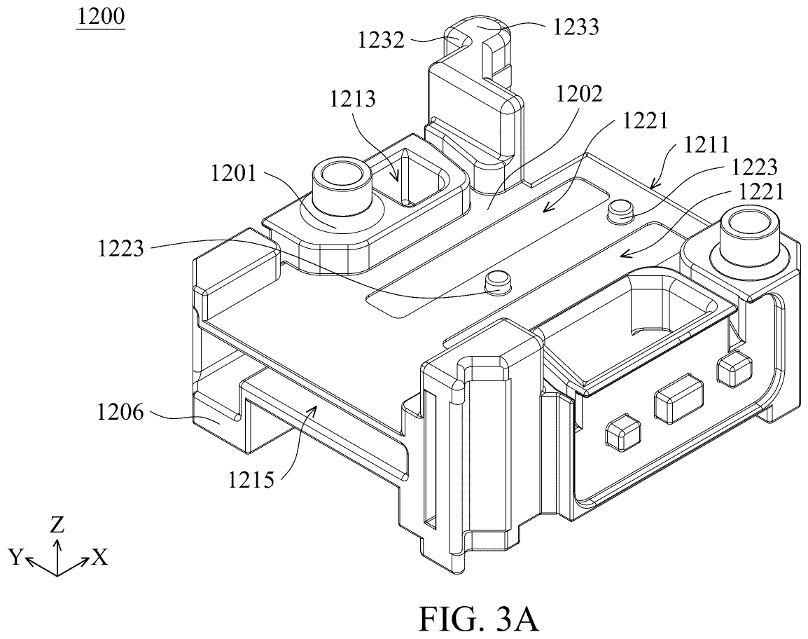

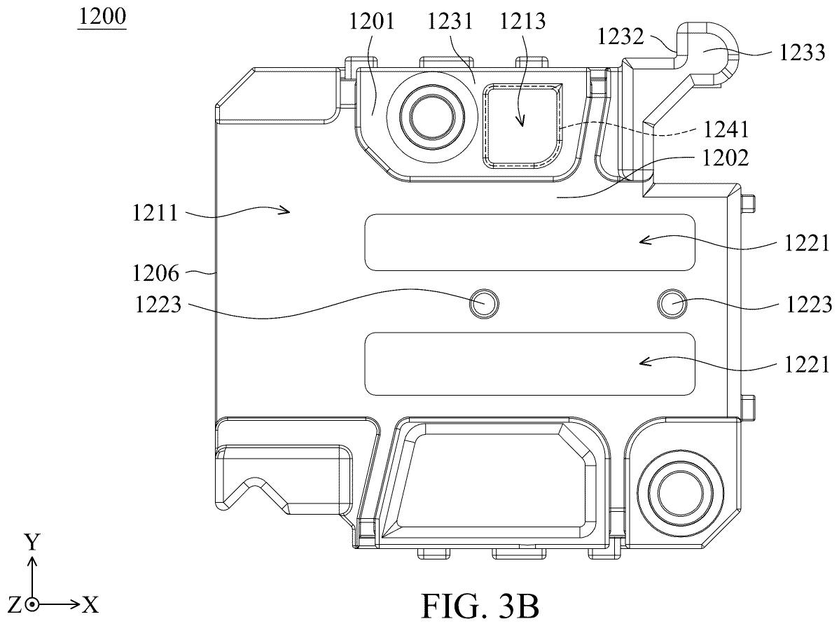

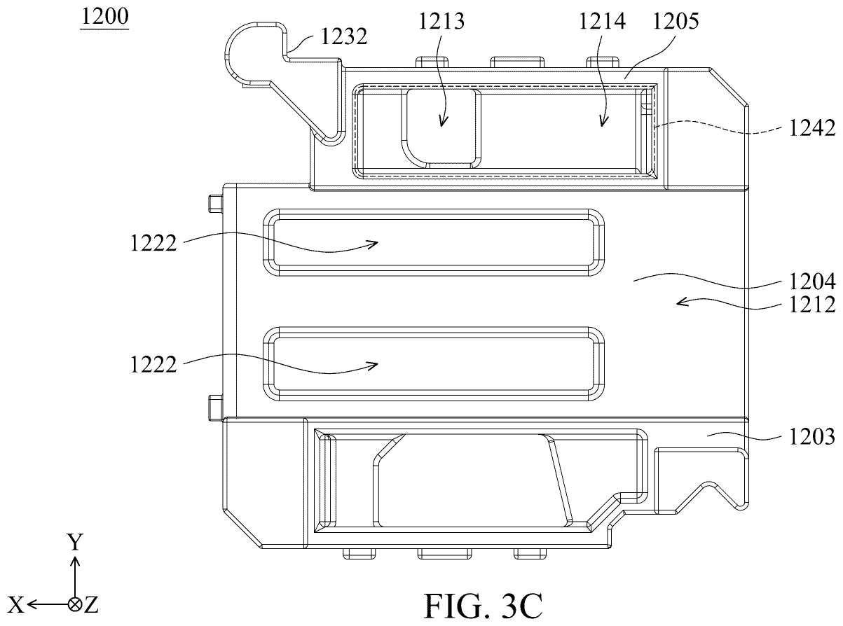

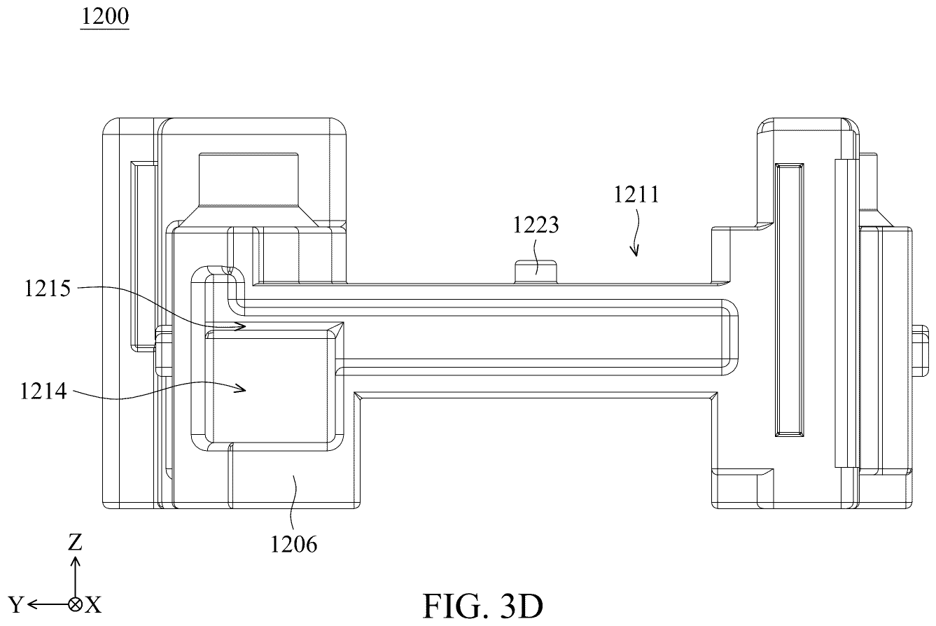

In some embodiments, various lightweight structures (such as grooves, openings, etc.) may be provided on the movable portion 1200 to reduce the weight of the movable portion. FIG. 3A is a schematic view of the movable portion 1200. FIG. 3B is a top view of the movable portion 1200. FIG. 3C is a bottom view of the movable portion 1200. FIG. 3D is a side view of the movable portion 1200. As shown in FIG. 3A to FIG. 3D, the movable portion 1200 may have a first recess 1211 on one side and a second recess 1212 on another side.

In some embodiments, as shown in FIG. 2D, FIG. 3A, and FIG. 3B, the first recess 1211 may be formed on the first surface 1201 of the movable portion 1200 and have a recessed structure. Additionally, a first connection reinforcing structure 1221 may be provided within the first recess 1211, such as formed on a second surface 1202 in the first recess 1211 and having a recessed structure. Furthermore, as shown in FIG. 2D and FIG. 3C, the second recess 1212 may be formed on the third surface 1203 of the movable portion 1200 and have a recessed structure. A second connection reinforcing structure 1222 may be provided within the second recess 1212, such as formed on a fourth surface 1204 in the second recess 1212 and having a recessed structure.

In some embodiments, the depth 1921 of the first connection reinforcing structure 1221 is different from the depth 1922 of the second connection reinforcing structure 1222. For example, the depth 1921 of the first connection reinforcing structure 1221 may be less than the depth 1922 of the second connection reinforcing structure 1222. In some embodiments, in the direction perpendicular to the fourth surface 1204 (along the Z axis), the first connection reinforcing structure 1221 and the second connection reinforcing structure 1222 may at least partially overlap each other to achieve miniaturization. In some embodiments, the first connection reinforcing structure 1221 and the second connection reinforcing structure 1222 may also penetrate each other in the direction perpendicular to the fourth surface 1204 to further reduce the weight of the movable portion 1200, depending on design requirements.

In some embodiments, as shown in FIG. 3A to FIG. 3D, the movable portion 1200 may further include a third recess 1213, a fourth recess 1214, and a fifth recess 1215, which are formed on the first surface 1201, the fifth surface 1205, and the sixth surface 1206, respectively. The first surface 1201 and the fifth surface 1205 may face different directions, such as facing opposite directions. The sixth surface 1206 may not be parallel to either the first surface 1201 or the fifth surface 1205. In some embodiments, the third recess 1213 may be connected to the fourth recess 1214, and the fifth recess 1215 may be directly connected to the fourth recess 1214, and connected to the third recess 1213 through the fourth recess 1214.

In some embodiments, as shown in FIG. 3B and FIG. 3C, the third recess 1213 may have a first profile 1241 on the first surface 1201, and the fourth recess 1214 may have a second profile 1242 on the fifth surface 1205. The first profile 1241 and the second profile 1242 may have different geometrical shapes and areas, such as the area of the first profile 1241 may be smaller than the area of the second profile 1242.

In some embodiments, as shown in FIG. 3B, the movable portion 1200 may further include a first side wall 1231 adjacent to the third recess 1213 and the fourth recess 1214, and the first coil 1302 of the first driving element 1301 may be disposed on the first side wall 1231, as shown in FIG. 2D. In the direction perpendicular to the first side wall 1231 (the Y direction) which has a plate-shaped structure, the first driving element 1301 may at least partially overlap with the third recess 1213, the fourth recess 1214, and the fifth recess 1215. Moreover, in the direction perpendicular to the first side wall 1231, the first recess 1211 may at least partially overlap with the third recess 1213, and the second recess 1212 may at least partially overlap with the fourth recess 1214. The third recess 1213 may at least partially overlap with both of the first connection reinforcing structure 1221 and the second connection reinforcing structure 1222, and the fourth recess 1214 may also at least partially overlap with the second connection reinforcing structure 1222. In the direction perpendicular to the first surface 1201, the first fixing structure 1224 may at least partially overlap with the fourth recess 1214.

In some embodiments, the first surface 1201 and the second surface 1202 may face the same direction, and the third surface 1203 and the fourth surface 1204 may face the same direction. In some embodiments, the first surface 1201 and the third surface 1203 may face different directions, such as the first surface 1201 and the third surface 1203 may face opposite directions. In some embodiments, the first surface 1201 and the third surface 1203 may be perpendicular to the main axis 1900. Furthermore, as shown in FIG. 2B and FIG. 2D, the second surface 1202 may face the first circuit 1401, and the fourth surface 1204 may face the second circuit 1402. In some embodiments, the second surface 1202 may be in direct contact with the first circuit 1401, and the fourth surface 1204 may be in direct contact with the second circuit 1402.

In some embodiments, additional connecting elements may be provided between the movable portion 1200 and the circuit assembly 1400 to fix the relative positions of the movable portion 1200 and the circuit assembly 1400. For example, as shown in FIG. 2D, a first connecting element 1251 may be provided in the first connection reinforcing structure 1221 to contact the movable portion 1200 and the first circuit 1401. A second connecting element 1252 may be provided between the fourth surface 1204 and the second circuit 1402 to contact the movable portion 1200 and the second circuit 1402. In some embodiments, the second connecting element 1252 may be partially located within the second connection reinforcing structure 1222. Therefore, the relative positions of the movable portion 1200 and the circuit assembly 1400 may be fixed. In some embodiments, the first connecting element 1251 and the second connecting element 1252 may be, for example, optical adhesive, thermosetting adhesive, moisture-curing adhesive, or AB adhesive (including elements such as acrylic, epoxy, polyurethane, etc.), but it is not limited thereto.

In some embodiments, as shown in FIG. 2B, the first circuit 1401, the second circuit 1402, and the third circuit 1403 may be formed as one piece. For example, the first circuit 1401 may connect the second circuit 1402 through the third circuit 1403. In some embodiments, the first circuit 1401, the second circuit 1402, and the third circuit 1403 may be plate-shaped, wherein the first circuit 1401 and the second circuit 1402 being parallel to each other and non-parallel to the third circuit 1403. For example, the first circuit 1401 and the second circuit 1402 may be parallel to the second surface 1202, and the third circuit 1403 is not parallel to the second surface 1202. In some embodiments, the first circuit 1401 may be at least partially located in the first recess 1211, and the second circuit 1402 may be at least partially located in the second recess 1212. Additionally, the second circuit 1402 may include a first flexible structure 1404, at least partially located within the second recess 1212, which provides flexibility. Therefore, the movable portion 1200 may be movably connected to the fixed portion 1100 through the circuit assembly 1400.

In some embodiments, a position sensing element 1450 may be disposed on the third circuit 1403, and a second magnetic element 1451 may be disposed on the frame 1120. The second magnetic element 1451 corresponds to the position sensing element 1450, such as the second magnetic element 1451 at least partially overlap the position sensing element 1450 along the X axis. The position sensing element 1450 may be used to detect changes in the magnetic field of the second magnetic element 1451 to get the position of the movable portion 1200 relative to the fixed portion 1100. For example, the position sensing element 1450 may include a Hall sensor, a magnetoresistance effect sensor (MR sensor), a giant magnetoresistance effect sensor (GMR sensor), a tunneling magnetoresistance effect sensor (TMR sensor), or a fluxgate sensor.

In some embodiments, the third circuit 1403 may further include a first reinforcing element 1441, and the first reinforcing element 1441 is plate-shaped and includes metal. The first reinforcing element 1441 and the position sensing element 1450 may be disposed on opposite sides of the third circuit 1403. In some embodiments, the first reinforcing element 1441 is parallel to the third circuit 1403 and not parallel to the second surface 1202. Moreover, the magnetic permeability of the first reinforcing element 1441 may be lower than the magnetic permeability of the second magnetic element 1451. As a result, the mechanical strength at the third circuit 1403 may be enhanced and magnetic interference may be prevented.

In some embodiments, a second reinforcing element 1442 may be provided on the first flexible structure 1404 of the second circuit 1402, such as may be disposed at a bending portion of the first flexible structure 1404 to restrict the bending behavior of the first flexible structure 1404. In some embodiments, the first reinforcing element 1441 and the second reinforcing element 1442 may have different structures (geometrical shapes). For instance, the first reinforcing element 1441 may be plate-shaped, and the second reinforcing element 1442 may be columnar-shaped and may extend in the Y direction. In some embodiments, the thickness 1913 of the first reinforcing element 1441 and the thickness 1914 of the second reinforcing element 1442 may be different along the X axis, such as the thickness 1913 may be less than the thickness 1914 to further reinforce the mechanical strength of the bending portion of the first flexible structure 1404.

In some embodiments, as shown in FIG. 2E and FIG. 3A to FIG. 3C, the movable portion 1200 may further include a first guiding portion 1232 and a first stopper portion 1233. The first guiding portion 1232 has a recessed structure corresponding to the support assembly 1500, such as may directly contact the first support element 1510. In some embodiments, the first stopper portion 1233 may be used to limit the movement range of the movable portion 1200. For example, when the movable portion 1200 is in a first position (as shown in FIG. 2E), the first stopper portion 1233 may contact the fixed portion 1100, such as may be in direct contact with the frame 1120 to limit the movable range of the movable portion 1200 along the Z axis.

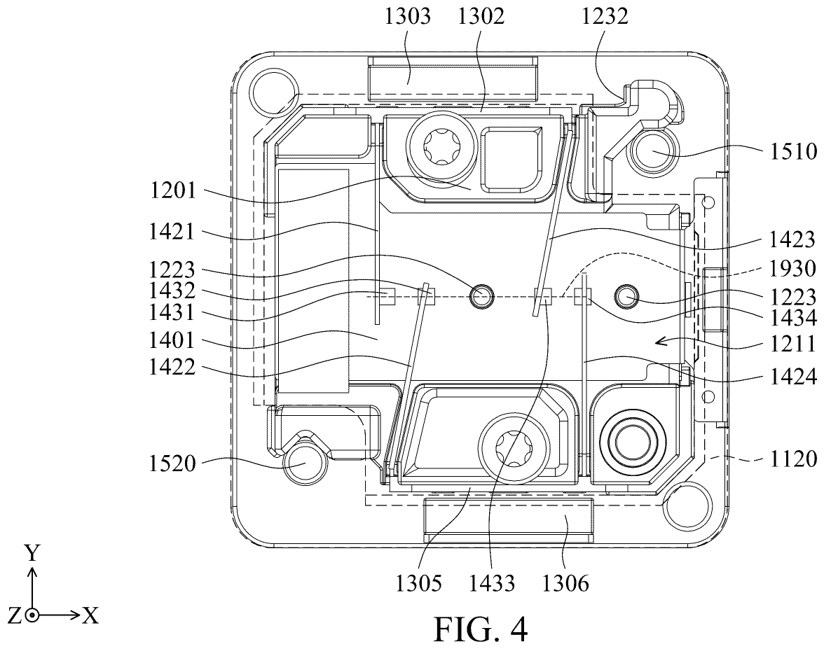

FIG. 4 is a top view of some elements of the optical element driving mechanism 1000. In some embodiments, as shown in FIG. 2D and FIG. 4, the movable portion 1200 may include a first positioning structure 1223 protruding from the second surface 1202 in the +Z direction and passes through the first circuit 1401 to define the position of the first circuit 1401 relative to the movable portion 1200. In some embodiments, the height 1923 of the first positioning structure 1223 is less than the depth 1924 of the first recess 1211, wherein the depth 1924 may be defined as the distance from the first surface 1201 to the second surface 1202.

In some embodiments, as shown in FIG. 2B and FIG. 4, the circuit assembly 1400 may further include a first guiding wire 1421, a second guiding wire 1422, a third guiding wire 1423, and a fourth guiding wire 1424. In some embodiments, the first guiding wire 1421, the second guiding wire 1422, the third guiding wire 1423, and the fourth guiding wire 1424 may be disposed sequentially along a connection line 1930. In other words, the connection line 1930 may pass through the first guiding wire 1421, the second guiding wire 1422, the third guiding wire 1423, and the fourth guiding wire 1424. The first guiding wire 1421, the second guiding wire 1422, the third guiding wire 1423, and the fourth guiding wire 1424 may be located in the first recess 1211, and they may be electrically connected to the first circuit 1401.

For example, the first guiding wire 1421, the second guiding wire 1422, the third guiding wire 1423, and the fourth guiding wire 1424 may be electrically connected to the first circuit 1401 through a first electrical connecting element 1431, a second electrical connecting element 1432, a third electrical connecting element 1433, and a fourth electrical connecting element 1434, respectively. In some embodiments, the first electrical connecting element 1431, the second electrical connecting element 1432, the third electrical connecting element 1433, and the fourth electrical connecting element 1434 may also be disposed sequentially along the connection line 1930. The first electrical connecting element 1431, the second electrical connecting element 1432, the third electrical connecting element 1433, and the fourth electrical connecting element 1434 may, include conductive methods such as soldering, fusing, or conductive adhesives, etc. Additionally, as shown in FIG. 2B, in the direction perpendicular to the second surface 1202, the first electrical connecting element 1431, the second electrical connecting element 1432, the third electrical connecting element 1433, and the fourth electrical connecting element 1434 at least partially overlap with the optical module 1600, and first electrical connecting element 1431, the second electrical connecting element 1432, the third electrical connecting element 1433, and the fourth electrical connecting element 1434 are located between the first circuit 1401 and the optical module 1600.

In some embodiments, the first guiding wire 1421 and the third guiding wire 1423 may be connected to the first coil 1302, while the second guiding wire 1422 and the fourth guiding wire 1424 may be connected to the third coil 1305 to provide power to the first coil 1302 and the third coil 1305 through the first circuit 1401.

In summary, an optical element driving mechanism is provided in some embodiments of the present disclosure, which includes a movable portion, a fixed portion, and a driving assembly. The movable portion is used for connecting to an optical module and is movable relative to the fixed portion. The driving assembly is used for driving the movable portion to move. Therefore, a miniaturized and lightweight optical element driving mechanism may be achieved, and the performance of the optical element driving mechanism may be enhanced.

The relative positions and size relationship of the elements in embodiments of the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a movable portion used for connecting an optical module;
a fixed portion, wherein the movable portion is movable relative to the fixed portion; and
a driving assembly used for driving the movable portion to move.

2. The optical element driving mechanism as claimed in claim 1, further comprising a circuit assembly, and the circuit assembly comprises a first circuit;
wherein:
the movable portion comprises:
a first surface;
a first recess formed on the first surface and having a recessed structure;
a second surface located on the first recess and facing the first circuit; and
a first positioning structure used for positioning the first circuit.

3. The optical element driving mechanism as claimed in claim 2, wherein:
the first surface and the second surface are parallel to each other;
the first positioning structure is protruding from the second surface; and
a height of the first positioning structure is less than a depth of the first recess.

4. The optical element driving mechanism as claimed in claim 3, wherein:
the movable portion further comprises:
a first connecting element, wherein the first circuit is electrically connected to the movable portion through the first connecting element; and
a first connection reinforcing structure having a recessed structure formed in the second surface.

5. The optical element driving mechanism as claimed in claim 4, wherein the circuit assembly further comprises:
a first guiding wire located in the first recess;
a second guiding wire located in the first recess;
a third guiding wire located in the first recess;
a first electrical connecting element disposed on the first circuit;
a second electrical connecting element disposed on the first circuit; and
a third electrical connecting element disposed on the first circuit.

6. The optical element driving mechanism as claimed in claim 5, wherein:
the first connecting element directly contacts the first connection reinforcing structure;
the first electrical connecting element is located on the first recess;
the first guiding wire electrically connects the first circuit through the first electrical connecting element;
the second guiding wire electrically connects the first circuit through the second electrical connecting element; and
the third guiding wire electrically connects the first circuit through the third electrical connecting element.

7. The optical element driving mechanism as claimed in claim 6, wherein:
a connection of the first electrical connecting element and the second electrical connecting element passes through the third electrical connecting element when viewed in a direction perpendicular to the first surface;
the first electrical connecting element at least partially overlaps with the optical module in a direction perpendicular to the second surface;
the first electrical connecting element is located between the first circuit and the optical module.

8. The optical element driving mechanism as claimed in claim 7, wherein:
the circuit assembly further comprises a first connector at least partially located in the first recess;
a height of the first connector is greater than the depth of the first recess; and
the optical module further comprises a second connector corresponding to the first connector.

9. The optical element driving mechanism as claimed in claim 8, wherein:
the circuit assembly further comprises a second circuit;
the movable portion further comprises:
a third surface facing a different direction from the first surface;
a second recess formed on the third surface and having a recessed structure;
a fourth surface located on the second recess;
a second connecting element, wherein the second circuit is electrically connected to the movable portion through the second connecting element; and
a second connection reinforcing structure having a recessed structure formed in the fourth surface.

10. The optical element driving mechanism as claimed in claim 9, wherein:
the second circuit is at least partially located on the second recess;
the third surface and the fourth surface are parallel to each other;
a depth of the second connection reinforcing structure is different from a depth of the first connection reinforcing structure;
the first connection reinforcing structure and the second connection reinforcing structure at least partially overlap each other in a direction perpendicular to the fourth surface.

11. The optical element driving mechanism as claimed in claim 10, wherein:
the second circuit comprises a first flexible structure;
the first flexible structure is at least partially located on the second recess; and
the second circuit and the first circuit are formed as one piece.

12. The optical element driving mechanism as claimed in claim 11, wherein the movable portion further comprises:
a third recess formed in the first surface;
a fourth recess formed in a fifth surface; and
a first side wall adjacent to the third recess.

13. The optical element driving mechanism as claimed in claim 12, wherein:
the first surface and the fifth surface face different directions;
the third recess is connected to the fourth recess;
the third recess has a first profile on the first surface; and
the fourth recess has a second profile on the fifth surface;
an area of the first profile is different from an area of the second profile;
the first side wall is adjacent to the fourth recess;
the driving assembly comprises a first driving element disposed on the first side wall;
the first side wall is plate-shaped.

14. The optical element driving mechanism as claimed in claim 13, wherein:
the first driving element at least partially overlaps with the third recess in a direction perpendicular to the first side wall;
the first driving element at least partially overlaps with the fourth recess in the direction perpendicular to the first side wall;
the third recess at least partially overlaps with the first recess in the direction perpendicular to the first side wall;
the fourth recess at least partially overlaps with the second recess in the direction perpendicular to the first side wall;
the fourth recess at least partially overlaps with the second connection reinforcing structure in the direction perpendicular to the first side wall;
the third recess at least partially overlaps with the first connection reinforcing structure in the direction perpendicular to the first side wall;
the third recess at least partially overlaps with the second connection reinforcing structure in the direction perpendicular to the first side wall; and
the depth of the second connection reinforcing structure is greater than the depth of the first connection reinforcing structure.

15. The optical element driving mechanism as claimed in claim 14, further comprising a third connecting element, wherein the movable portion further comprises:
a sixth surface facing a different direction from the first surface;
a fifth recess formed on the sixth surface and having a recessed structure; and
a first fixing structure used for fixing the optical module.

16. The optical element driving mechanism as claimed in claim 15, wherein:
the sixth surface and the third surface face different directions;
the fifth recess is connected to the fourth recess;
the fifth recess is connected to the third recess;
the first driving element at least partially overlaps with the fifth recess in the direction perpendicular to the first side wall;
the optical module is affixed to the movable portion through the third connecting element;
the third connecting element directly contacts the first fixing structure;
the third connecting element comprises a screw or a nut;
the first fixing structure is located on the first surface;
the first fixing structure at least partially overlaps with the fourth recess in the direction perpendicular to the first surface.

17. The optical element driving mechanism as claimed in claim 14, further comprising a support assembly and a first protection assembly, wherein:
the movable portion further comprises:
a first guiding portion having a recessed structure; and
a first stopper portion used for limiting a movable range of the movable portion;
the first guiding portion corresponds to the support assembly;
the first stopper portion contacts the fixed portion when the movable portion is at a first position;
the movable portion is movable relative to the fixed portion through the support assembly.

18. The optical element driving mechanism as claimed in claim 17, wherein:
the first driving element comprises a first coil and a first magnetic element;
the first protection assembly is located between the first coil and the first magnetic element;
the first protection assembly comprises resin or plastic;
the first protection assembly is plate-shaped; and
the first protection assembly is fixedly connected to the fixed portion.

19. The optical element driving mechanism as claimed in claim 11, further comprising a second magnetic element and a position sensing element, wherein:
the circuit assembly further comprises:
a third circuit electrically connected to the first circuit; and
a first reinforcing element disposed on the third circuit;
the second magnetic element is disposed on the fixed portion;
the third circuit is plate-shaped;
the third circuit is not parallel to the second surface;
the first reinforcing element is plate-shaped;
the first reinforcing element comprises metal;
a magnetic permeability of the first reinforcing element is lower than a magnetic permeability of the second magnetic element
the first reinforcing element is not parallel to the second surface;
the first circuit is electrically connected to the second circuit through the third circuit; and
the position sensing element is at least partially disposed on the third circuit.

20. The optical element driving mechanism as claimed in claim 19, wherein:
the circuit assembly further comprises a second reinforcing element disposed on a bending portion of the first flexible structure;
the first reinforcing element and the second reinforcing element have different structures;
the second reinforcing element is strip-shaped; and
a thickness of the second reinforcing element is greater than a thickness of the first reinforcing element.
